(19) United States
(12) Patent Application Publication
(10) Pub. No.: US 2025/0316724 A1
(43) Pub. Date: Oct. 9, 2025

(54) REINFORCED DATUM RAIL FOR FUEL CELL STACK SYSTEMS

(71) Applicant: GM Global Technology Operations LLC, Detroit, MI (US)

(72) Inventors: Venkata Kommisetti, Rochester Hills, MI (US); Ronald Miller, Bloomfield Hills, MI (US); Purushothama Siddappaji, Bengaluru (IN); Bhuvaneswara Rao Dharmavarapu, Rochester Hills, MI (US)

(73) Assignee: GM Global Technology Operations LLC, Detroit, MI (US)

(21) Appl. No.: 18/626,875

(22) Filed: Apr. 4, 2024

(51) Int. Cl. H01M 8/0276; H01M 8/0282; H01M 8/0284

(52) U.S. Cl. CPC H01M 8/0276; H01M 8/0282; H01M 8/0284

(57) ABSTRACT

A datum rail for a fuel cell stack system including a body extending along a longitudinal axis, including a first end, a second end opposite the first end, a channel extending between the first end and the second end, and one or more through holes extending through the body with respect to the longitudinal axis. The datum rail further including at least one rod arranged in each of the one or more through holes and extending between the first end and the second end.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a datum rail for fuel cell systems and. more particularly, to a reinforced datum rail for fuel cell systems.

In general, a fuel cell stack system requires assembling (e.g., stacking) one or more plates that are eventually compressed together into a stack. One or more guides or support rails may be used during assembly to constrain and align the one or more plates with respect to one another. The one or more guides or support rails commonly remain in the stack after the assembly process is completed and can act as an insulator to a metal casing surrounding the stack. Existing guides or support rails are fragile and typically do not perform well under mechanical loads that vehicles can encounter. Shortcomings of existing devices and systems will be addressed by one or more aspects of the present disclosure.

### SUMMARY

According to one aspect, a datum rail for a fuel cell stack system is provided and includes a body extending along a longitudinal axis, including a first end, a second end opposite the first end, a channel extending between the first end and the second end, and one or more through holes extending through the body with respect to the longitudinal axis. The datum rail further including at least one rod arranged in each of the one or more through holes and extending between the first end and the second end.

Implementations of the disclosure may include one or more of the following optional features. In some examples, the body may include a first flange and a second flange that each extends between the first end and the second end with respect to the longitudinal axis. One of the one or more through holes may be arranged through the first flange with respect to the longitudinal axis and another one of the one or more through holes may be arranged through the second flange with respect to the longitudinal axis. The channel may be arranged laterally between the first flange and the second flange.

According to another example, the channel may be configured to correspond with an alignment feature arranged in a fuel cell housing of each of one or more fuel cells.

According to at least one aspect, the body is made of an insulating material and the at least one rod is made of a different material than the body. The insulating material may be plastic. The at least one rod may be made of metal. The at least one rod may be made of steel.

According to another aspect, the at least one rod can reinforce the body against forces that are orthogonal to the longitudinal axis.

According to one aspect, a fuel cell stack assembly is provided and includes a fuel cell stack case comprising a chamber, one or more fuel cells arranged in the chamber of the fuel cell stack case, and one or more datum rails aligning the one or more fuel cells with respect to each other and separating the one or more fuel cells from the fuel cell stack case. The one or more datum rails includes a body extending with respect to a longitudinal axis, including a first end, a second end opposite the first end, and one or more through holes extending through the body with respect to the longitudinal axis. The one or more datum rails further includes at least one rod arranged in each of the one or more through holes and extending between the first end and the second end.

Implementations of the disclosure may include one or more of the following optional features. In some examples, the body includes a first flange and a second flange that each extends between the first end and the second end with respect to the longitudinal axis. One of the one or more through holes may be arranged through the first flange with respect to the longitudinal axis and another one of the one or more through holes may be arranged through the second flange with respect to the longitudinal axis. The body may include a channel arranged laterally between the first flange and the second flange. The channel may be configured to correspond with an alignment feature arranged in fuel cell housings of each of the one or more fuel cells.

According to at least one example, the body is made of an insulating material and the at least one rod is made of a different material than the body. The insulating material may be plastic. The at least one rod may made of metal. The at least one rod may made of steel.

According to at least one aspect, the at least one rod can reinforce the body against forces that are orthogonal to the longitudinal axis.

### BRIEF DESCRIPTION OF THE DRAWINGS

The drawings described herein are for illustrative purposes only of selected configurations and are not intended to limit the scope of the present disclosure.

FIG. 1 is a perspective view of a fuel cell stack case according to principles of the present disclosure;

FIG. 2 is a perspective view of one or more fuel cells arranged with respect to one or more datum rails according to the principles of the present disclosure;

FIG. 3 is a top view of the one or more fuel cells and one or more datum rails of FIG. 2;

FIG. 4 is an exploded view of a datum rail according to the principles of the present disclosure;

FIG. 5 is a cross-sectional view of the datum rail of FIG. 4 along line 5-5; and

FIG. 6 is a front view of the datum rail of FIG. 4.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising.” “including.” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on.” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein. the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry. integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from. and to transmit data and instructions to, a storage system, at least one input device, and at least one output device.

The processes and logic flows described in this specification can be performed by one or more programmable processors. also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

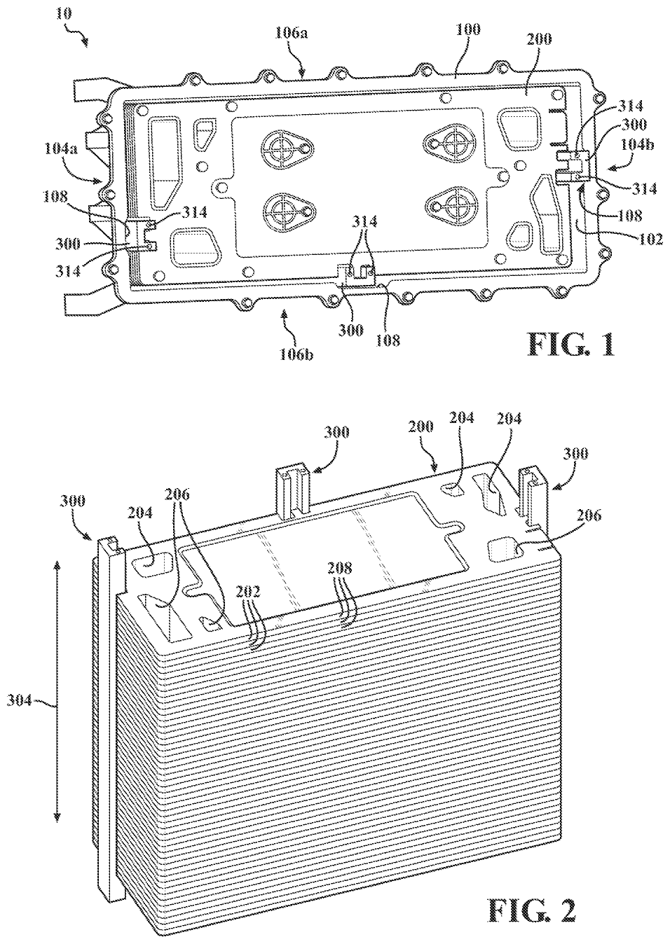

Referring to FIG. 1, a fuel cell stack assembly 10 is provided for illustration of principles of the present disclosure. The fuel cell stack assembly 10 includes a fuel cell stack case 100, a fuel cell stack 200, and one more rails, such as one or more alignment or datum rails 300. In general, the fuel cell stack case 100 can be arranged to protect the fuel cell stack 200 from forces that can result from high or low impact impacts, for example. The fuel stack case 100 can have a chamber 102 having one or more walls made of metal or another material typically used to produce fuel cell stack cases. For instance, the chamber 102 can include at least a first set of parallel walls 104a, 104b and a second set of parallel walls 106a, 106b. The chamber 102 can further include upper and lower panels (not shown) that are configured to be coupled to the walls 104a, 104b, 106a, 106b in a fluid tight manner, for example. According to one aspect of the present disclosure, one or more of the walls 104a, 104b, 106a, 106b can include one or more slots 108 that are configured to accommodate or otherwise align the one or more datum rails with respect to the fuel cell stack case 100. The walls 104a, 104b, 106a. 106b or other aspects of the chamber 102 may include additional features (e.g., clips, slots, fasteners, etc.) for aligning, housing, or supporting the one or more datum rails 300 with respect to the fuel cell stack case 100.

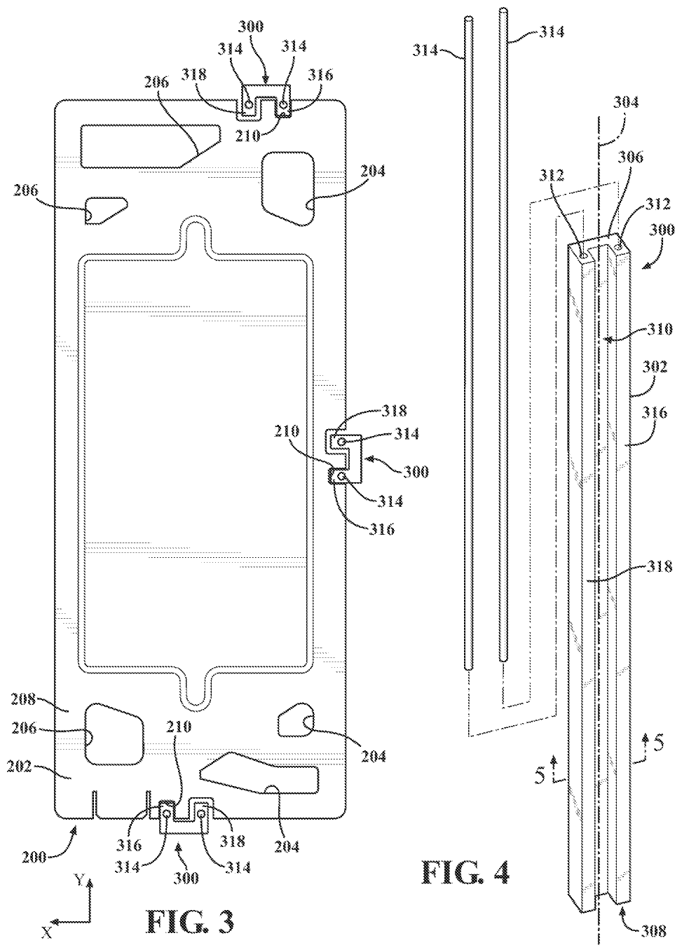

With reference to FIG. 2, the fuel cell stack 200 includes one or more fuel cells 202 that are arranged laterally between the one or more datum rails 300. The fuel cell stack 200 can include one or more supply passages 204 and one or more discharge passages 206 so that fluids such as gas, fuel gas, coolant gas, etc. can flow through the fuel cell stack 200. The one or more fuel cells 202 each includes a membrane electrode (not shown) sandwiched within a fuel cell housing 208. The fuel cell housing 208 may be formed via stamping or another method of manufacturing fuel cell components, for example. During assembly of the fuel cell stack 200, it may be desirable for each fuel cell 202 to align precisely with the other fuel cells 202 in the fuel cell stack 200 before the fuel cells 202 are compressed together, for example. Thus, each fuel cell housing 208 may include one or more alignment features (e.g., grooves, cut outs, etc.) 210 for aligning the fuel cells 202 within the fuel cell stack 200, as shown in FIG. 3.

With reference again to FIG. 1, the one or more datum rails 300 may be arranged between the fuel cell stack 200 and walls 104a, 104b, 106a, 106b of the chamber 102. In other words, the one or more datum rails 300 may separate the fuel cell stack 200 from the chamber 102, which may be desirable to insulate the fuel cell stack 200 from being shorted by a metal fuel cell stack case 100. Additionally, the one or more datum rails 300 may be configured to align the one or more fuel cells 202 of the fuel cell stack 200. With reference to FIG. 4, the one or more datum rails 300 may include a body 302 extending along a longitudinal axis 304. The body 302 can have a first end 306, second end 308 opposite the first end 306, and a channel 310 extending between the first end 306 and the second end 308. The body 302 may be made of plastic, a lightweight material, or another material used to manufacture datum rails for fuel cell stacks, for example. The body 302 may include one or more through holes 312 that extend through the body 302 in a direction parallel to the longitudinal axis 304. The one or more datum rails 300 further include one or more rods 314 that may be arranged in the one or more through holes 312. The one or more rods 314 may be made of metal, a reinforcing material, or a material that is stronger than plastic, for example. Thus, the material of the body 302 may be different than the material of the one or more rods 314.

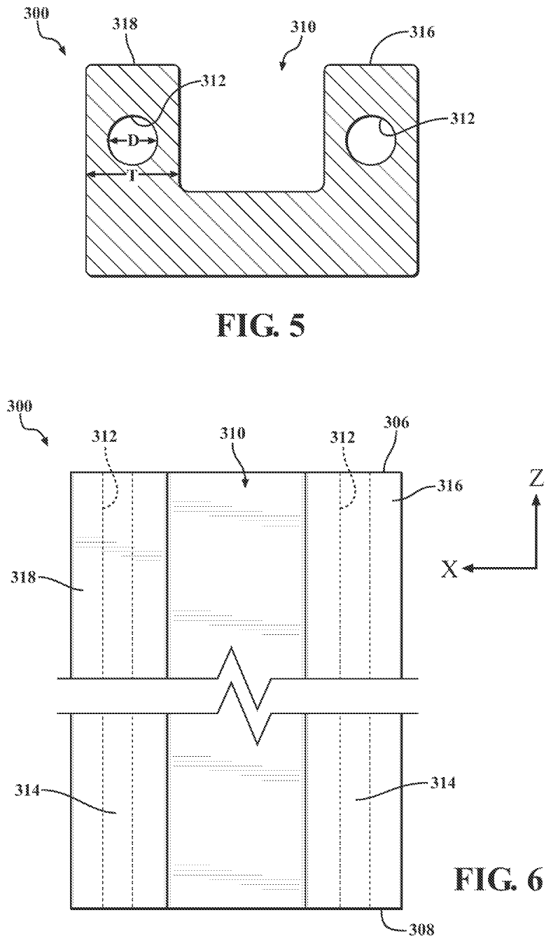

According to at least one configuration, the body 302 can have a C-shaped or U-shaped cross section, as shown in FIG. 5. In other words, the body 302 can include a first flange 316 and a second flange 318 that each extends axially between the first end 306 and the second end 308 with respect to the longitudinal axis 304. The first and second flanges 316, 318 may each have a thickness T. The one or more through holes 312 may include two through holes, one of which being arranged through the first flange 316 and the other being arranged through the second flange 318. Each of the one or more through holes 312 may have a diameter D which is less than the thickness T. The diameter D of the one or more through holes 312 may be determined based on a diameter of the one or more rods 314. In other words, the one or more rods 314 can be inserted in the one or more through holes 312 and coupled to the body of the datum rails 300 (e.g., using an adhesive). In the present configuration, the channel 310 is arranged laterally between the first flange 316 and the second flange 318 and is configured so that the first flange 316 and the second flange 318 may correspond with the one or more alignment features 210 of the fuel cell housing 208.

In assembly, with reference to FIG. 3, the one or more fuel cells 202 may be arranged on the one or more datum rails 300 by aligning the first and second flanges 316, 318 of each datum rail 300 with the alignment features 210 of the fuel cell housing 208. Upon installation, each fuel cell 202 is constrained along a respective plane that is perpendicular to the longitudinal axis 304.

As indicated above, vehicles can experience forces as a result of low speed or high speed impacts with other objects such as other vehicles, potholes, buildings, trees, etc. These forces can result in damage to one or more aspects of the vehicle. For instance, the fuel cell stack assembly 10 can be affected by these forces. Reinforcing the datum rails 300 with one or more rods 314 may be desirable to mitigate and/or minimize the effect of the one or more forces that the vehicle can experience from time to time. With reference to FIG. 6, when the datum rail 300 is reinforced with the one or more rods 314 that are made of steel and the datum rail is subjected to lateral force (e.g., at 27 kN) along a path parallel to the x-axis 12 (i.e., orthogonal to the longitudinal axis), the datum rail 300 can exhibit up to about 5-6.2 mm of deflection. In comparison to prior datum rails, the datum rail 300 can exhibit about 50-60% less deflection when subjected to a lateral force along a path parallel to the x-axis 12.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A datum rail for a fuel cell stack system, comprising:
a body extending along a longitudinal axis, comprising:
a first end,
a second end opposite the first end,
a channel extending between the first end and the second end, and
one or more through holes extending through the body with respect to the longitudinal axis; and
at least one rod arranged in each of the one or more through holes and extending between the first end and the second end.

2. The datum rail of claim 1, wherein the body comprises a first flange and a second flange that each extends between the first end and the second end with respect to the longitudinal axis.

3. The datum rail of claim 2, wherein one of the one or more through holes is arranged through the first flange with respect to the longitudinal axis and another one of the one or more through holes is arranged through the second flange with respect to the longitudinal axis.

4. The datum rail of claim 3, wherein the channel is arranged laterally between the first flange and the second flange.

5. The datum rail of claim 1, wherein the channel is configured to correspond with an alignment feature arranged in a fuel cell housing of each of one or more fuel cells.

6. The datum rail of claim 1, wherein the body is made of an insulating material and the at least one rod is made of a different material than the body.

7. The datum rail of claim 6, wherein the insulating material is plastic.

8. The datum rail of claim 7, wherein the at least one rod is made of metal.

9. The datum rail of claim 8, wherein the at least one rod is made of steel.

10. The datum rail of claim 1, wherein the at least one rod reinforces the body against forces that are orthogonal to the longitudinal axis.

11. A fuel cell stack assembly, comprising:
a fuel cell stack case comprising a chamber;
one or more fuel cells arranged in the chamber of the fuel cell stack case; and
one or more datum rails aligning the one or more fuel cells with respect to each other and separating the one or more fuel cells from the fuel cell stack case;
wherein the one or more datum rails comprises:
a body extending with respect to a longitudinal axis, comprising:
a first end,
a second end opposite the first end, and
one or more through holes extending through the body with respect to the longitudinal axis; and
at least one rod arranged in each of the one or more through holes and extending between the first end and the second end.

12. The fuel cell stack assembly of claim 11, wherein the body comprises a first flange and a second flange that each extends between the first end and the second end with respect to the longitudinal axis.

13. The fuel cell stack assembly of claim 12, wherein one of the one or more through holes is arranged through the first flange with respect to the longitudinal axis and another one of the one or more through holes is arranged through the second flange with respect to the longitudinal axis.

14. The fuel cell stack assembly of claim 13, wherein a channel is arranged laterally between the first flange and the second flange.

15. The fuel cell stack assembly of claim 14, wherein the channel is configured to correspond with an alignment feature arranged in fuel cell housings of each of the one or more fuel cells.

16. The fuel cell stack assembly of claim 11, wherein the body is made of an insulating material and the at least one rod is made of a different material than the body.

17. The fuel cell stack assembly of claim 16, wherein the insulating material is plastic.

18. The fuel cell stack assembly of claim 17, wherein the at least one rod is made of metal.

19. The fuel cell stack assembly of claim 18, wherein the at least one rod is made of steel.

20. The fuel cell stack assembly of claim 11, wherein the at least one rod reinforces the body against forces that are orthogonal to the longitudinal axis.
